(19) United States
(12) Patent Application Publication
(10) Pub. No.: US 2014/0350827 A1
(43) Pub. Date: Nov. 27, 2014

(54) RESTARTING DEVICE OF INTERNAL COMBUSTION ENGINE

(71) Applicants: Osamu Mukaihara, Hitachinaka (JP); Kenichi Machida, Hitachinaka (JP)

(72) Inventors: Osamu Mukaihara, Hitachinaka (JP); Kenichi Machida, Hitachinaka (JP)

(73) Assignee: HITACHI AUTOMOTIVE SYSTEMS, LTD, Ibaraki (JP)

(21) Appl. No.: 14/241,264

(22) PCT Filed: Aug. 7, 2012
(86) PCT No.: PCT/JP12/70064

§ 371 Date: Feb. 26, 2014

(30) Foreign Application Priority Data
Aug. 30, 2011 (JP) 2011-186981

(51) Int. Cl. F02D 29/02

(52) U.S. Cl. CPC F02D 29/02; F02N 2200/02
USPC 701/113

(57) ABSTRACT

An automobile control device includes a function that can control drive torque of a starting device to an arbitrary value, and a positive rotation detecting unit having at least one of a function to detect whether an engine rotates positively and a function to detect whether the engine does not rotate reversely. The control device also has an idle stop function to increase the drive torque of the starting device when the positive rotation detecting unit detects that the engine rotates positively or does not rotate reversely. Accordingly, problems of malfunctions such as a reduction in a system voltage, abnormal wear of a brush in a starter motor, and breakage of a semiconductor switch are solved that are found in a conventional automobile control device having the idle stop function and that are caused by flowing of overcurrent when a starter is driven during swing-over that occurs immediately before engine stop.

### TECHNICAL FIELD

The present invention relates to a restarting device of an internal combustion engine and particularly to a restarting device of an internal combustion engine in a vehicle of fuel consumption saving type in which idling is terminated during a temporary stop of the vehicle in consideration of energy source saving and environmental conservation.

### BACKGROUND ART

In some automobiles, for purposes of energy source saving and environmental conservation, idle stop has been suggested and performed when a specified condition to permit temporary engine stop during an operation of the automobile is satisfied. In the automobile with this idle stop function, a system that further increases fuel consumption efficiency can be realized by proactively performing the idle stop in a deceleration state (a coasting area) before the vehicle is stopped.

However, in the system for performing the idle stop in the coasting area, the engine has to be started immediately to secure responsiveness of the vehicle when a restarting request is made between a time at which fuel cut is started and a time of engine stop. Accordingly, PTL1 describes a technique in which a starter motor is energized while a speed thereof is controlled during inertia revolution of the engine after the fuel cut, a pinion that is coaxially provided with the starter motor meshes with a ring gear that is included in the engine when a rotational speed of the pinion synchronizes a rotational speed of the ring gear, and the engine is thereby immediately restarted by driving the starter.

### CITATION LIST

### Patent Literature

PTL 1: JP-A-2010-106825

### SUMMARY OF INVENTION

### Technical Problem

However, when the engine is stopped, swing-over (a phenomenon that the engine rotates reversely with respect to a rotational direction thereof) may occur immediately before the engine stop due to an influence of a combustion pressure of each cylinder or the like.

In the vehicle that performs the idle stop in the coasting area, a restarting request is made to secure the responsiveness. However, if cranking is performed during the swing-over, a load on the starter motor increases, a voltage of the system is substantially reduced, and a stable system operation may be hindered.

In addition, because the excessive load is applied by driving the starter motor during the swing-over, a brush in the starter motor may abnormally be worn. Furthermore, when a semiconductor switch or the like is used to drive the motor, a current consumption during the swing-over largely exceeds a current consumption during the normal operation. In a worst case, serious failure such as breakage of a semiconductor may occur.

Thus, it can be considered as a simplest method to prohibit driving of a starting device for a certain period in a specified area near the engine stop (for example, an area where an engine speed is below 50 r/min) regardless of occurrence of the swing-over. However, because this raises a problem of degraded responsiveness of the vehicle or the like, it has been an issue to solve this problem.

### Solution to Problem

In order to solve the above problem, an automobile control device according to the invention having an idle stop function includes: a function to control drive torque of a starting device to an arbitrary value; and a positive rotation detecting unit that has at least one of a function to detect whether an engine rotates positively and a function to detect whether the engine does not rotate reversely, and, when the positive rotation detecting unit detects that the engine rotates positively or does not rotate reversely, the drive torque of the starting device is increased.

This specification includes the contents disclosed in the specification and/or drawings of Japanese Patent Application No. 2011-186981, which is entitled to claim priority for the subject application.

### Advantageous Effects of Invention

According to the invention, a state that overcurrent flows through a starter (particularly, a starter motor and an electric line of the motor) is recognized by detecting a rotational direction of the engine, and a period in which the starter is driven and the drive torque are controlled on the basis of the state. Accordingly, a starting device can be driven without sacrificing startability while system components are protected and a reduction in voltage is kept in an allowable range.

### BRIEF DESCRIPTION OF DRAWINGS

FIG. 1 shows a functional configuration of a system in a first embodiment that is an example of an automobile control device according to the invention.

FIG. 2 shows the functional configuration of the system in a second embodiment that is another example of the automobile control device according to the invention.

FIG. 3 is a flowchart of a method of controlling the control device (first and second embodiments) according to the invention.

FIG. 4 shows an example of a timing chart in a case where the control device (first and second embodiments) of the invention executes control.

FIG. 5 shows an example of a timing chart in a case where detection of a positive rotation is made in the control device (first and second embodiments) according to the invention.

FIG. 6 shows an example of a timing chart in a case where the control device (a third embodiment) of the invention executes control.

FIG. 7 shows a change in combustion pressure of each cylinder with respect to a crank angle.

### DESCRIPTION OF EMBODIMENTS

A description will hereinafter be made on embodiments that embody modes for carrying out the invention.

### EMBODIMENTS

### First Embodiment

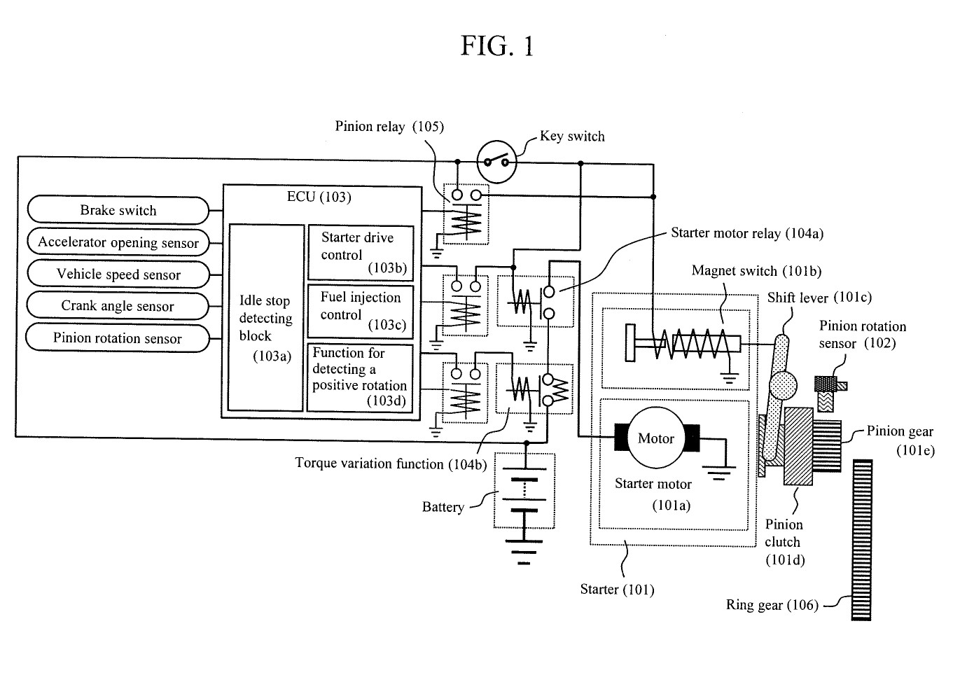

FIG. 1 shows a functional configuration of a system in a first embodiment that is an example of an automobile control device according to the invention.

A starter main body is configured of a starter motor (101a), a magnet switch (101b), a shift lever (101c), a pinion clutch (101d), a pinion gear (101e), and the like. A starter motor relay (104a) and a pinion relay (105) that are independent power source relays are controlled by output of an engine control unit (ECU) (103), and the starter motor (101a) and the magnet switch (101b) are thereby driven.

The starter motor (101a) and the pinion gear (101e) are coaxially coupled and are configured such that, when the starter motor (101a) rotates, the pinion gear (101e) also rotates. The shift lever (101c) is structured such that it is operated when the magnet switch (101b) is energized and that another end thereof pushes the pinion gear (101e) to couple the pinion gear (101e) to a ring gear (106) included in an engine.

In addition to normal fuel injection control (103c), ignition control (not shown), and electronic throttle control (electronic throttle control) (not shown), the ECU (103) detects idle stop permission in an idle stop detecting block (103a) based on information from various sensors such as a brake SW and a vehicle speed sensor.

In addition, the ECU (103) includes a function for detecting a positive rotation (103d) to detect whether the engine rotates positively or whether the engine does not rotate reversely. Based on a detection result of this function for detecting the positive rotation (103d), a starter drive control function (103b) controls a starter motor relay (104a) and a torque variation function (104b), thereby driving the starter motor (101a) with the arbitrary drive torque.

### Second Embodiment

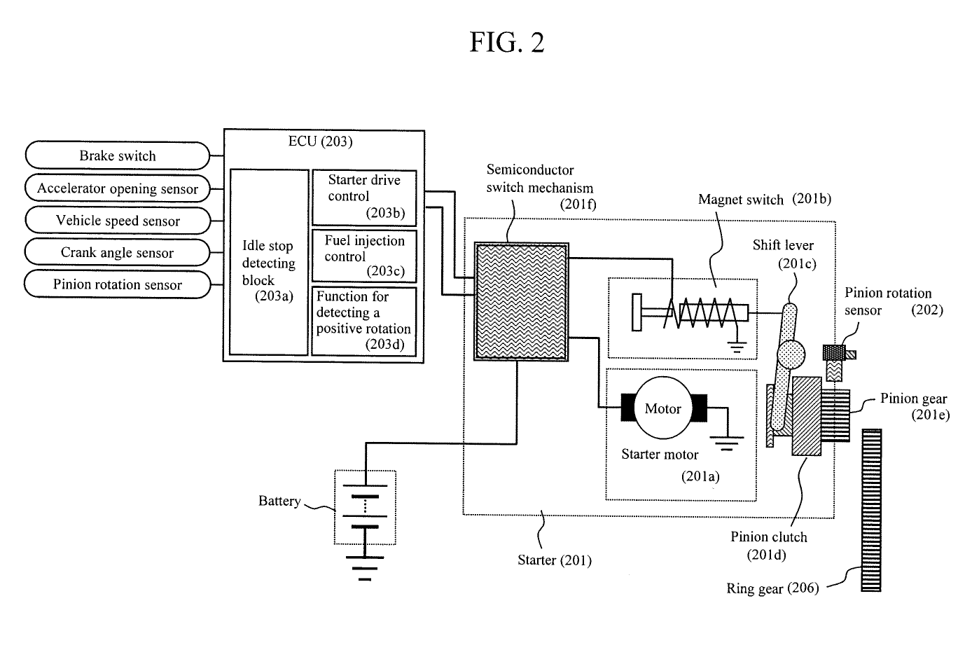

Next, a second embodiment of the invention will be described. FIG. 2 shows the functional configuration of the system in the second embodiment that is another example of the automobile control device according to the invention.

A starter main body (201) is configured of a starter motor (201a), a magnet switch (201b), a shift lever (201c), a pinion clutch (201d), a pinion gear (201e), a semiconductor switch mechanism (201f), and the like.

First, a starter drive signal is output by starter drive control (203b) of an engine control unit (ECU) (203) to the semiconductor switch mechanism (201f). The starter drive signal includes two systems of the magnet switch (201b) for controlling a function for energizing the starter motor (201a) and a function for pushing out the pinion gear (201e), and separately controls the starter motor (201a) and the magnet switch (201b) by operating each of MOSFETs in the semiconductor switch mechanism (201f) at different duty ratio.

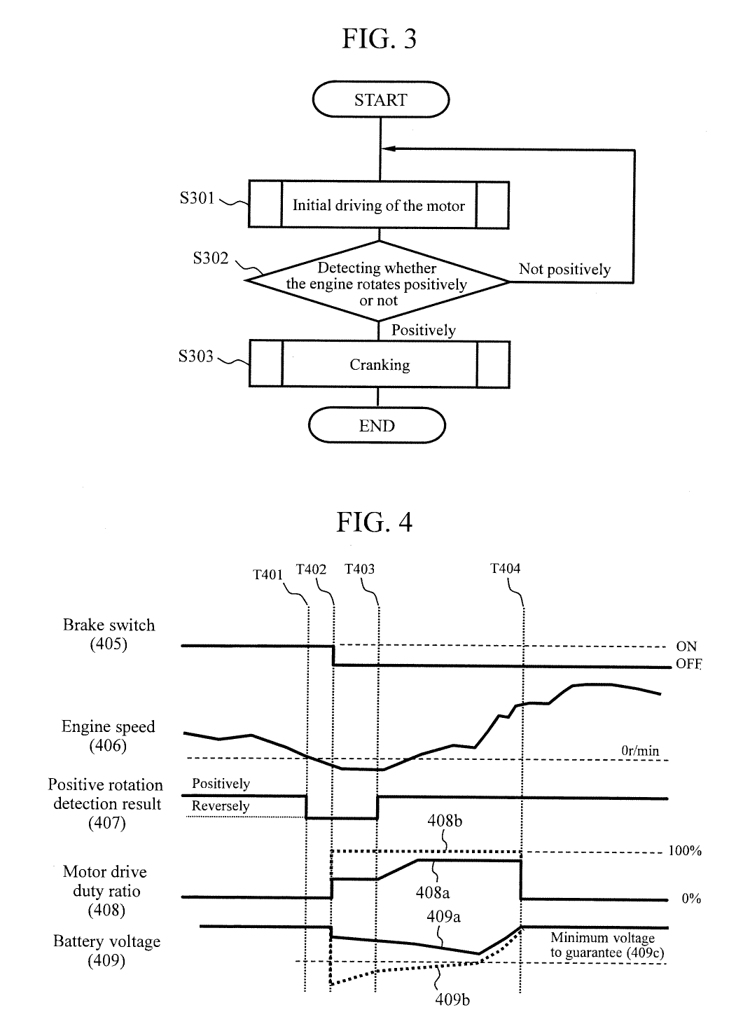

Next, a basic method of controlling the first and second embodiments of the invention will be described by using FIG. 3 and FIG. 4.

FIG. 3 is a flowchart of a method of controlling each of the control devices (first and second embodiments) according to the invention. This flow is executed at specified time intervals (10 ms, for example).

A sequence during initial driving of the motor is executed in a step S301. Here, the starter motor is driven to generate preset drive torque. More specifically, in the control device of the first embodiment shown in FIG. 1, the torque variation function (104b) is used to control the torque after the starter motor relay (104a) is turned ON. In other words, when the ECU switches OFF the relay of the torque variation function (104b), a current is applied to the starter motor (101a) through a resistor in the torque conversion function (104b). Accordingly, compared to a state that the current does not flow through the resistor, it is possible to suppress the generated torque of the starter motor (101a). Thus, in the step S301, the resistor in the torque variation function (104b) is used to control the starter motor (101a) to generate the preset drive torque.

Meanwhile, in the control device of the second embodiment shown in FIG. 2, because the semiconductor switch mechanism (201f) performs the above function, the ECU (203) provides a signal indicative of specified drive duty ratio to the semiconductor switch mechanism (201f).

Alternatively, in the initial diving of the motor in the step S301, the starting device may not be operated until it is detected that the engine rotates positively or that the engine does not rotate reversely. In other words, the starter motor relay (104a) is not turned ON in the control device of the first embodiment shown in FIG. 1 while the signal indicative of the duty ratio for driving the motor is not output to the semiconductor switch mechanism (201f) in the control device of the second embodiment shown in FIG. 2.

Next, a process proceeds to a step S302 to make at least one of the detection of whether the engine rotates positively and the detection of whether the engine rotates reversely. Although the detail will be described below, if each of the functions for detecting the positive rotation (103d, 203d) detect in this step that the engine rotates positively or that the engine does not rotate reversely, the process proceeds to a cranking sequence (engine start) in a step S303. On the other hand, if a condition of the step S302 is not satisfied (the engine rotates reversely), the process returns to the step S301 and repeats the above operations until a condition of the step S303 is satisfied (it is detected that the engine rotates positively or that the engine does not rotate reversely).

In the step S303, the current applied to each of the starter motors (101a, 201a) is increased to actually perform the cranking. At this time, in the first embodiment (FIG. 1), as described above, the ECU (103) turns ON the torque variation function (104b), and the current is thereby applied to the starter motor (101a) without flowing through the resistor in the torque variation function (104b). In addition, in the second embodiment (FIG. 2), the ECU (203) controls the semiconductor switch mechanism (201f) to increase the motor drive duty ratio. Each of the magnet switches (101b, 201b) is turned ON in a series of such control.

Next, the details of control by the control device of the invention will be described. FIG. 4 shows an example of a timing chart in a case where each of the control device (first and second embodiments) of the invention executes control. FIG. 4 shows a brake switch (405), an engine speed (406), a positive rotation detection result (407), motor drive duty ratio (408), and a battery voltage (409) from the top.

First, fuel cut is performed due to permission of the idle stop, and the engine exhibits a stopping behavior and stops completely thereafter. A series of these behaviors are shown by a change in the engine speed (406). The swing-over (a temporary phenomenon of reverse rotation of the engine) occurs in a process to the engine stop and is detected by each of the functions for detecting the positive rotation (103d, 203d), and the detection result is shown as the positive rotation detection result (407).

In the example shown in FIG. 4, it is detected that the engine rotates reversely (does not rotate positively) in a period from a time T401 to a time T403. In addition, at a time T402, the brake switch (405) is turned OFF from ON. Because this indicates a starting or restarting request intended by a driver, the idle stop permission is immediately canceled to proceed to a restarting sequence.

In the restarting sequence, the motor drive duty ratio (408a) is set to a specified value and remains so until the time T403. In other words, the step S301 shown in FIG. 3 is performed from the time T402 to the time T403. In addition, if the starting device is not operated until it is detected that the engine rotates positively or it is detected that the engine does not rotate reversely, the starter motor is not driven from the time T401 to T403, and thus the abnormal voltage reduction is completely prevented.

It is detected at the time T403 by the function for detecting the positive rotation that the engine rotates positively, and the motor drive duty ratio is increased thereafter to drive the starter motor at the specified drive duty ratio. Although not shown, each of the magnet switches (101b, 201b) remains ON from the time T402 to a time T404 at which it is detected that the restarting of the engine is completed. Because the battery voltage (409) exhibits a behavior shown by a battery voltage (409a) due to these operations and satisfies a minimum voltage to guarantee (409c) that is required for a stable operation of the system, it is possible to improve the responsiveness at the starting.

For reference, FIG. 4 shows drive duty ratio (408b) of the starter motor in a case where a conventional mechanical relay is used. In this case, because the drive duty ratio is constantly 100%, a rush current to the electric line of the motor is large. In addition, because the starter motor is driven under a condition that a load thereon is set to the maximum, a battery voltage (409b) greatly falls below the minimum voltage to guarantee (409c). On the other hand, the control device of the invention produces a superior effect that the battery voltage can be prevented from falling below the minimum voltage to guarantee (409c).

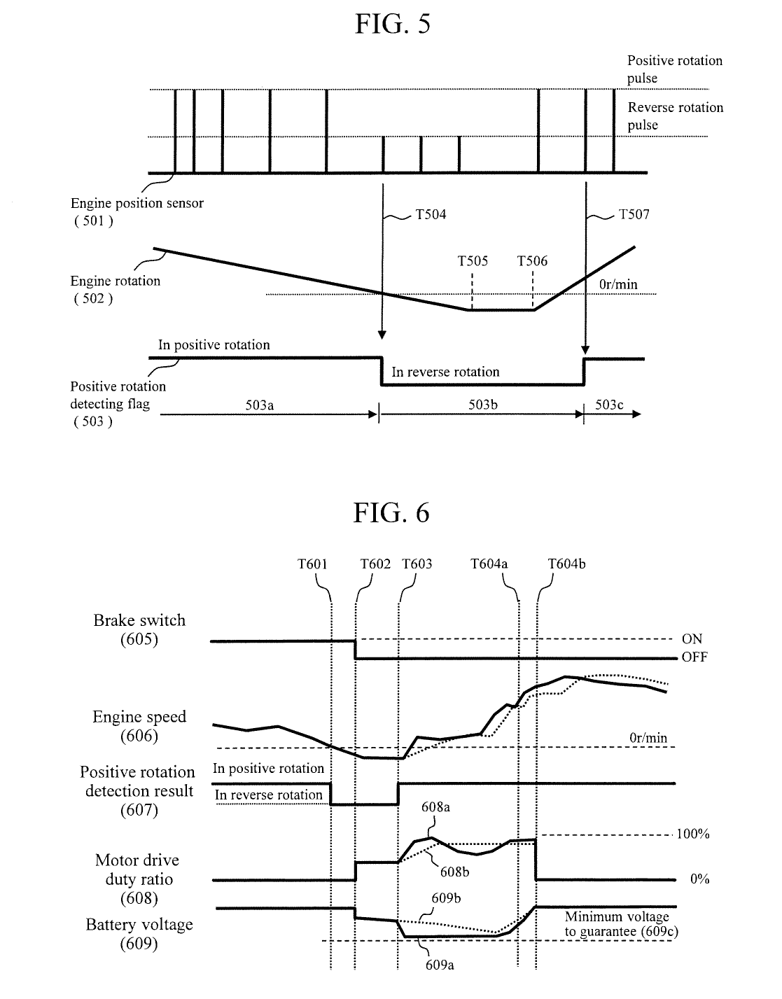

Next, a description will be made on the function for detecting the positive rotation of the control device (first and second embodiments) according to the invention. FIG. 5 shows an example of a timing chart in a case where each of the control devices (first and second embodiments) according to the invention detects a positive rotation. FIG. 5 shows output of an engine position sensor (501), an engine speed (502), and a positive rotation detection flag (503) from the top.

The engine position sensor used in the first and second embodiments has a characteristic that an output value thereof varies according to a rotational direction of the engine, and the functions for detecting the positive rotation (103d, 203d) of the ECUs (103, 203) each has the function for detecting the positive rotation to detect that the engine rotates positively when a signal of the positive rotation engine is detected for specified times or more (twice in a row, for example) based on the output from the engine position sensor (501).

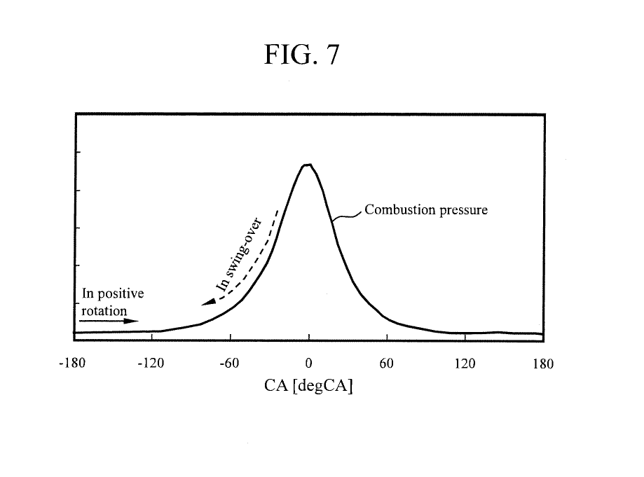

In addition, the function for detecting the positive rotation may detect the rotational direction of the engine on the basis of a lapse of time of a combustion pressure that can be obtained by a unit capable of detecting or estimating at least one combustion pressure or more. More specifically, a combustion pressure of each cylinder exhibits a constant change based on a crank angle as shown in FIG. 7. This results from a change in volume caused by closing of an intake valve, opening of an exhaust valve, and vertical movement of a piston; however, when the swing-over occurs, as shown by a broken line in the drawing, a phenomenon occurs that the combustion pressure is reduced at a crank angle at which the combustion pressure is normally increased. Considering the above, it is possible to detect the positive rotation by detecting a difference in the combustion pressure between the time of the positive rotation and the time of the swing-over by the unit capable of detecting or estimating the combustion pressure.

First, each of the ECUs (103, 203) performs the fuel cut based on each idle stop condition and stops the engine. At this time, the engine revolves inertially (the engine speed is reduced from the fuel cut to the engine stop). Because the rotational direction of the engine during the inertia revolution indicates the positive rotation, the engine position sensor (501) outputs the signal of the positive rotation engine. Corresponding to this, the detection result of the function for detecting the positive rotation is the positive rotation detection flag (503a) indicative of the positive rotation. Then, the swing-over occurs before the engine stop.

Once the swing-over occurs, the engine position sensor (501) outputs a signal of the reverse rotation engine at a time T504, and the function for detecting the positive rotation detects that the engine has rotated reversely (503b) since the time T504 at which the signal of the reverse rotation engine is detected. Then, the cranking is performed by using the specified initial drive torque (in the step S301 shown in FIG. 3), and reverse rotation torque generated by the swing-over is damped. Accordingly, the engine starts rotating in the positive rotational direction again at a time T506. The engine position sensor (501) starts outputting the signal of the positive rotation engine from the time T506; however, in the first and second embodiments, as described above, it is detected that the engine rotates positively from the time when the signal of the positive rotation engine is detected twice. Accordingly, the function for detecting the positive rotation detects the positive rotation from a time T507 (503c).

The first and second embodiments according to the invention have been described so far; however, the function for detecting the positive rotation is not limited to the above.

### Third Embodiment

Next, a third embodiment of the invention will be described. FIG. 6 shows an example of a timing chart in a case where the control device (third embodiment) of the invention executes control. FIG. 6 shows a brake switch (605), an engine speed (606), a positive rotation detection result (607), motor drive duty ratio (608), and a battery voltage (609) in a descending order.

First, the fuel cut is performed due to the permission of the idle stop, and the engine exhibits a stopping behavior and stops completely thereafter. The series of these behaviors are shown by the engine speed (606) in FIG. 6, and the swing-over (the temporary phenomenon of reverse rotation of the engine) occurs in the middle of the process. The detection result made by the function for detecting the positive rotation is shown as the positive rotation detection result (607).

In the example shown in FIG. 6, it is detected that the engine rotates reversely (does not rotate positively, in other words) in a period from a time T601 to a time T603. In addition, in FIG. 6, timing at which the brake switch (605) turns OFF from ON is set to a time T602. Because this indicates the starting or restarting request intended by the driver, the idle stop permission is immediately canceled to proceed to the restarting sequence. In the restarting sequence, the motor drive duty ratio (608a) is set to a specified value and remains so until the time T603. In other words, the step S301 of FIG. 3 is performed in a period from the time T602 to the time T603.

Because the function for detecting the positive rotation detects that the engine rotates positively at the time T603 onward (a right side in the drawing), the motor drive duty ratio is increased thereafter, and the starter motor is driven at the specified drive duty. In order to prevent the battery voltage from falling below the minimum voltage to guarantee at this time (see the battery voltage 609a in FIG. 6), the motor drive duty ratio (608a) is configured to be controlled on the basis of at least one type of the information on the crank angle, the engine speed, the pinion rotational speed, the combustion pressure, and the battery voltage.

For example, when the battery voltage is reduced and approximates the minimum voltage to guarantee, it is necessary to suppress the reduction in the battery voltage by reducing the drive duty. However, this leads to loss of the drive torque required for the cranking, and the continuation of the cranking may become difficult. Accordingly, the drive torque in an area where the battery voltage is relatively high is increased so as to increase the rotational speed of the pinion, and an inertia force is then increased to compensate for the loss of the drive torque, which is caused by the reduced drive duty. More specifically, the drive torque required for the cranking (required drive duty, in other words) depends on the crank angle, and, as the piston approximates compression top dead center, friction of the engine is increased, and the required drive torque is increased. In other words, when a degree of reduction of the battery voltage becomes the maximum and the piston reaches the compression top dead center, the crank angle is changed to a certain angle by the inertia force of the engine, and thus the required drive torque is reduced. Accordingly, because it is possible to estimate the required and demanded drive torque by detecting this state from the crank angle, the engine speed, the rotational speed of the pinion, the combustion pressure, and the battery voltage, the starter is controlled on the basis of this such that the battery voltage becomes constant.

For reference, FIG. 6 shows transitions of the change in the motor duty ratio (608b) in a case where the control is executed at the preset motor drive duty ratio in each of the control devices of the first and second embodiments.

In the third embodiment, the control can be executed to obtain a flat battery voltage (609a) as shown in FIG. 6 that does not fall below the minimum voltage to guarantee (609c); therefore, it is possible to efficiently start the engine.

### DESCRIPTION OF REFERENCE NUMERALS AND SIGNS

101: starter (main body), 101a: starter motor, 101b: magnet switch, 101c: shift lever, 101d: pinion clutch, 101e: pinion gear, 102: pinion rotation sensor,
103: ECU, 103a: idle stop detection, 103b: starter drive control, 103c: fuel injection control, 103d: function for detecting a positive rotation,
104a: starter motor relay, 104b: torque variation function, 105: pinion relay, 106: ring gear,
201: starter (main body), 201a: starter motor, 201b: magnet switch, 201c: shift lever, 201d: pinion clutch, 201e: pinion gear, 201f: semiconductor switch mechanism, 202: pinion rotation sensor,
203: ECU, 203a: idle stop detection, 203b: starter drive control, 203c: fuel injection control, 203d: function for detecting a positive rotation,
T401: time at which the engine is detected to rotate reversely,
T402: time at which the brake switch is turned off from on,
T403: time at which the engine is detected to rotate positively,
T404: time at which restarting of the engine is detected to
be completed,
408: motor drive duty ratio, 408a: motor drive duty ratio of first and second embodiments, 408b: motor drive duty ratio in a case where the conventional mechanical relay is used, 409: battery voltage, 409a: battery voltage of first and second embodiments, 409b: battery voltage in a case where the conventional mechanical relay is used,
T504: time at which the engine is detected to rotate reversely,
T506: time at which the signal of the positive rotation engine starts being output, T507: time at which the signal of the positive rotation engine of engine is detected twice,
T601: time at which the engine is detected to rotate reversely,
T602: time at which the brake pedal is depressed (the starting request is made), T603: time at which the engine is detected to rotate positively, T604b: cranking termination timing,
608: motor drive duty ratio, 608a: motor drive duty ratio of the third embodiment, 608b: motor drive duty ratio of first and second embodiments, 609: battery voltage, 609a: behavior of battery voltage of the third embodiment, 609b: behavior of battery voltage of first and second embodiments, 609c: minimum voltage to guarantee.

All the publications, patents, and patent applications cited in this specification are incorporated herein by reference.

1. An automobile control device having an idle stop function comprising:
a function to control drive torque of a starting device of an engine to any value; and
a positive rotation detecting unit that has at least one of a function to detect whether the engine rotates positively and a function to detect whether the engine does not rotate reversely,
in that, when a restarting request of the engine is made, the starting device executes initial driving of the engine, and
when the positive rotation detecting unit detects that the engine rotates positively or does not rotate reversely, the drive torque of the starting device is increased to be larger than initial drive torque.

2. The automobile control device according to claim 1, wherein
when the initial driving is executed and the positive rotation detecting unit detects that the engine rotates positively or does not rotate reversely, the drive torque of the starting device is increased to be larger than the initial drive torque.

3. The automobile control device according to claim 2, wherein
the initial drive torque of the starting device is preset such that a specified voltage is generated, and
the drive torque of the starting device is increased to be larger than the initial drive torque.

4. The automobile control device according to claim 2, wherein
the drive torque of the starting device is not increased to be larger than initial drive torque until the positive rotation detecting unit detects that the engine rotates positively or does not rotate reversely.

5. The automobile control device according to claim 1, wherein
the positive rotation detecting unit is configured to make the detection based on an output value of a sensor that detects a rotational direction of the engine.

6. The automobile control device according to claim 1, wherein
the positive rotation detecting unit is configured to make the detection, based on a lapse of time of a combustion pressure that can be obtained by a unit capable of detecting or estimating at least one combustion pressure or more.

7. The automobile control device according to claim 1, wherein
after the positive rotation detecting unit makes the detection, the drive torque of the starting device is controlled on the basis of at least one type of information about a crank angle, an engine speed, a rotational speed of a pinion, a combustion pressure, and a battery voltage such that the battery voltage is not reduced to a desired voltage or lower.
